(19) United States
(12) Patent Application Publication
(10) Pub. No.: US 2026/0301330 A1
(43) Pub. Date: Oct. 1, 2026

(54) System and Method for Sharing Views of an Image Data Set

(71) Applicant: Novarad Corporation, Provo, UT (US)

(72) Inventors: Wendell Arlen Gibby, Mapleton, UT (US); Steven Todd Cvetko, Draper, UT (US)

(21) Appl. No.: 19/093,008

(22) Filed: Mar. 27, 2025

(51) Int. Cl. G06T 19/00; G06T 3/60; H04N 13/279

(52) U.S. Cl. CPC G06T 19/006; G06T 3/60; H04N 13/279

(57) ABSTRACT

Technology is described for sharing views of an image data set. The method can include determining a user view of the image data set based in part on a position of a first user in a 3D coordinate space defined using a wearable display device with associated sensors. Another operation may be sending the position of the first user in the 3D coordinate space to a rendering service which renders a first user view of the image data set from the position of the first user in the 3D coordinate system.

### BACKGROUND

Mixed or augmented reality is an area of computing technology where views from the physical world and images from virtual computing worlds may be combined into a mixed reality view for a user. In mixed reality, people, places, and objects from the physical world and virtual worlds become a blended visual and audio environment. A mixed reality experience may be provided through existing commercial or custom software along with the use of VR (virtual reality) or AR (augmented reality) headsets.

Augmented reality (AR) is an example of mixed reality where a live direct view (or an indirect view) of a physical, real-world environment is augmented or supplemented by computer-generated sensory input such as sound, video, graphics or other data. Augmentation is performed as a real-world location is viewed and in context with environmental elements. With the help of AR technology (e.g. adding computer vision and object recognition) the information about the surrounding real world of the user may become interactive and may be digitally modified.

### BRIEF DESCRIPTION OF THE DRAWINGS

FIG. 1 is a block diagram illustrating an example of a system and method for enabling users to share in a collaboration group and use of a local display.

FIG. 2 is a block diagram illustrating an example of a rendering service that can be hosted in a cloud computing service.

FIG. 3 is a diagram that illustrates an example of a first user view of the image data set which may be determined based in part on a position of a first user in a 3D coordinate space as defined using a first AR headset.

FIG. 4 illustrates an example of a slice of the image data set that may be viewed from a first user's perspective.

FIG. 5 is an image illustrating an example of the rendering service that may be able to control or manage navigation panels.

FIG. 6 is a flowchart illustrating an example of a method for displaying a user view of an image data set aligned with a body of a person during a medical procedure, as viewed using an AR headset.

FIG. 7 illustrates a computing device on which modules of this technology may execute.

FIG. 8 is a block diagram of a service provider environment according to an example of the present technology.

### DETAILED DESCRIPTION OF THE PREFERRED EMBODIMENTS

Reference will now be made to the examples illustrated in the drawings, and specific language will be used herein to describe the same. It will nevertheless be understood that no limitation of the scope of the technology is thereby intended. Alterations and further modifications of the features illustrated herein, and additional applications of the examples as illustrated herein, which would occur to one skilled in the relevant art and having possession of this disclosure, are to be considered within the scope of the description.

In order to use a wearable display or Augmented Reality (AR) headset in an operating room or similar medical procedure situation, a user of the AR headset or other wearable display may have a volume of data or an image data set that is superimposed onto a patient using the wearable display (e.g., AR headset). The image data set may be obtained prior to the medical procedure and may be one of many medical imaging modalities including: a CT (Computed Tomography scan), an MRI (Magnetic Resonance Imaging) image or other modalities described later.

A doctor may be performing a procedure, and the AR headset may be rendering the image data set in a certain view from the doctor's perspective and/or tracking an instrument and a patient. As a result, a doctor may be viewing a 2D slice or 3D volume of the image data set.

One way that medical professionals have shared images or video in the past is to make a video connection that would spool the video off the AR headset to other users using the appropriate streaming application and networking hardware. To perform this type of video streaming or image streaming a significant amount of graphics processor time and power is used to stream the video to a second system or another AR headset. This can drain a device's battery life, and receiving the video stream may also slow down any rendering occurring on the second device. In addition, a video or image stream does not provide a very good view of virtual objects (e.g., an image data set) that are being viewed because the video captures a large field of view but the image data set is only a small part of the large field of view. Thus, the image data set may only be 20%-30% of the visual display, which may appear small to the receiving user. Then as the receiving user (e.g., doctor) moves their head around, the doctor may also have confusing objects (e.g., the video stream) in the field of view. In other words, it may be hard for the receiving doctor to view reality, virtual reality objects and the video stream all together. So straight streaming of video between doctors is not an ideal way for doctors to share an image data set.

In the present technology, the users of an AR headset or wearable display can share, access and view an image data set (i.e., a data cloud) captured using medical imaging devices, and the users can avoid sharing a heavy bandwidth video stream between AR headsets. Rather than sharing a video stream, the users and devices can share just the coordinate information of a selected user with an AR headset and have a separate computer render that image data from the same perspective of the selected user. In this situation, the devices can send bits and bytes of user position, user head pose data, and a tracker location via Bluetooth or Wi-Fi.

This configuration allows the users of the AR headsets or wearable displays to connect to other users from across the world. The users can connect to a server to create a collaborative meeting or a remote session. The connection can have security protocols applied. The users connect to the server, and then when the server gets a request from another device, the server gives the device a code or QR code (or there is a login domain). An individual who already has permission to join the collaborative meeting can grant access to the server. Then data for positioning and orientation of an AR headset can be transferred and a rendering service or a remote AR headset can use that information to render portions or all of the image data from the perspective of the sending user or selected user. As a result, sharing a view of an image data set internationally (e.g., between the US and Mexico) may have almost no perceptible lag.

A technology is described that may provide the ability for a user with an AR headset to join a collaboration group that has one or more collaboration users. The collaboration group may allow one or more users to share a view for an image data set that is aligned with a body of a person (e.g., patient or subject) and include user interface controls and/or user interface information regarding viewing and navigating the image data set. In addition, a rendering service may be provided that can be part of the collaboration group. The rendering service may receive a view position for a selected user and render that user's view of the image data set. That view of the image data set may be sent to a 2D display or a wearable display (e.g., another stereoscopic display) that is located in the local operating room where the selected user is working or in another separate location. Accordingly, a user view of an image data set that is aligned with a body of a person as viewed through an AR headset or wearable display for a user in a medical procedure may be displayed on a separate 2D screen.

A shared interface may also be provided for users (e.g., medical professionals or doctors) in a collaboration group who are using AR headset technology in medical settings. Specifically, this technology may allow medical professionals to use AR headsets to see the user interface and views of image data set(s) (e.g., slices or the entire image data set) aligned with a patient during a medical procedure, as seen by a selected doctor using a different AR headset. This selected doctor or medical professional may be the designated medical professional for performing a medical procedure. The sharing may allow more than one medical professional to securely transmit the experience that a selected or designated medical professional is having through the AR headset to a rendering service which may send the rendering to a 2D display for individuals in a room (e.g., the operating room) who do not have a wearable device.

In an operating room (OR), one challenge for the medical team can be that the doctor(s) has the AR headset(s) which provides visualizations for the medical procedure but the other people in the room cannot see what visualizations the doctor is seeing. This technology can provide navigation and image data set alignment views on a larger 2D screen so medical professionals in the OR, who are not using an AR headset or a wearable display, can look at a larger 2D screen and see what visualization the doctor(s) in the room is viewing.

A computer with a rendering service, that is separate from the AR headsets or wearable displays being used, can be located in the room or at a separate location. A user view of a selected user who is using an AR headset or wearable display device can be sent to the rendering service. The AR headset or wearable display device may have associated sensors such as visual light cameras, infrared cameras, depth sensors, time-of-flight depth sensors, an inertial measurement sensor (e.g., accelerometer, gyroscope, magnetometer), microphones, or speakers. The sensors may be in or on the wearable display device or AR headset or the sensors may be at a distance from the wearable display device or AR headset but connected to the wearable display device or AR headset using a wireless or wired connection. The rendering service is connected to a 2D screen and a 3D projection of an image data set from the user view can be rendered on the 2D screen.

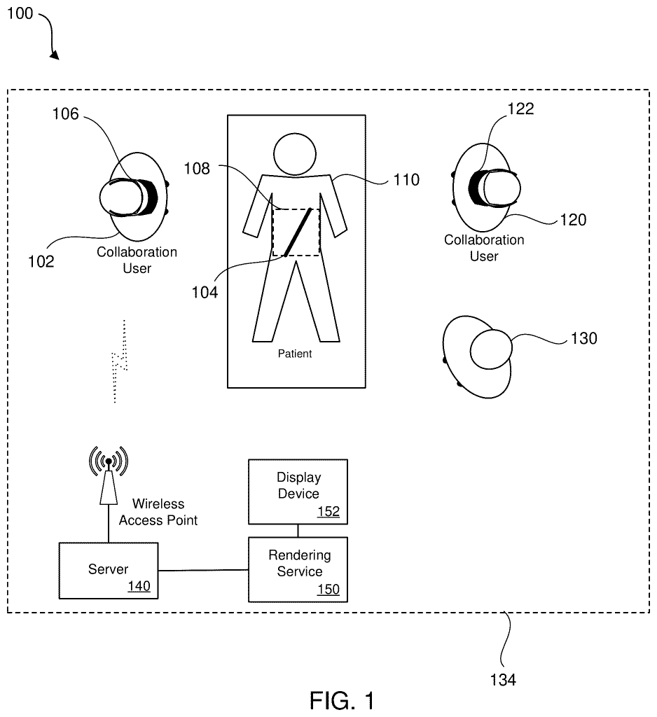

FIG. 1 illustrates a system 100 for enabling a user 102 with an AR headset 106 to share in a collaboration group. There may be one or more collaboration users 102, 120 in the collaboration group, for viewing an image data set 108 or a portion (e.g., a slice) of an image data set 108 aligned with a body of a person 110 using AR headsets 106, 122. A 3D coordinate space and/or a topology of a room may be detected using a sensor associated with the user's AR headset. The room may be an operating room 134, a surgical theater, an operating theater, a surgical procedure in an examination room, a surgical tent, or any confined location where a medical procedure is taking place, etc.

The system of FIG. 1 can be used for displaying an additional copy of a user view of an image data set that is aligned with a body of a person in the user's AR headset 106. For example, the image data set may be used during a medical procedure, as viewed using an AR headset. The system may include at least one processor or at least one memory device including a data store to store a plurality of data and instructions that perform the operations described below. The system may have the ability to share user views of an image data set and the user view may be shared locally or remotely and the user view of the image data set may share the same 3D coordinate space being viewed by other users.

A user view of the image data set may be determined based in part on a position of a first user 102 in a 3D coordinate space as viewed using a wearable display device. An example of a wearable display device may be an AR headset, a VR headset, a wearable monitor, or another wearable device that can present rendered or other images to a user. The position of the first user 130 in the 3D coordinate space can be sent to a rendering service 150. The position of the first user 130 may sent directly to the rendering service 150 via a wireless connection (e.g., Bluetooth or Wi-Fi) or the position of the first user 130 may be sent through a server 140 or other network type of routing devices (e.g., wireless access points, routers, etc.).

A first user view of the image data set can be rendered from the position of the first user in the 3D coordinate space using the rendering service 150. The rendering may be made from exactly the position of the first user or the rendering may be made from substantially a position of a first user that is near the first user or from an angle that is a bit different than the first user view, depending what is desired or needed. The first user view of the image data set can be received from the rendering service 150 by a display device 152 for display in the room 134 (e.g., operating room). This allows a portion of the image data set to be displayed from a perspective that matches the user view of the image data set. This display 152 may be a 2D screen or 3D display (e.g., a wearable or wearable holographic display) or some other type of display that can be used in the room. More specifically, the 2D display device may be at least one of: an LCD screen, an OLED screen, an image projector or a plasma screen that is located in an operating room or in a remote room. For example, a 2D display may be used that provides an image between 50 inches up to 150 inches. This additional display (e.g., a 2D screen) may be helpful for individuals in the room (e.g., operating room) that are not wearing head mounted displays or AR headsets in the operating room, because then other individuals in the room can see what the first user is seeing from the image data set or the combined the image data set and background images. For instance, a background image of the room or operating room may be composited together with a first user view of the image data set and the background image may be a still image or at least one frame from video from a camera of the AR headset or wearable display device. This may allow the viewer to see the image data set with a still background or even a video background. Displaying the rendered view of the image data set may mean that the image data set can be considered a shared image volume for those in the room or operating room.

This technology can render from the perspective of the first user of the image data set, and the system can perform the rendering without sending the image data set or any portion of the image data set to the rendering service 150. Instead, the position and orientation of the first user can be sent to the rendering service 150. The position and orientation data of the first user is a relatively small amount of data (e.g., a few bits or bytes of data). This arrangement avoids the streaming of network bandwidth heavy video, but rather the image data set or visual immersion cloud is obtained in advance by the rendering service, and then the first user view and/or navigation view can be rendered on the rendering service on a separate computer using very low data transfer bandwidth.

The rendering service 150 may be hosted on a rendering device located in proximity to where the AR headsets of the first user and/or second user are being operated. In one example, the AR headset of the first user 102 and the rendering service 150 are connected through at least one of: a collaboration server, Bluetooth or Wi-Fi. For example, the rendering device 150 may be hosted on a personal computer with a powerful graphics card that is located in an operating room. Alternatively, the rendering device 150 may be a dedicated hardware rendering computer that is configured to receive the position of the first user and generate a rendered output using the user view and the image data set (and optionally the first user view's user interface).

As mentioned, this technology can transfer the location and perspective for viewing virtual objects in the AR headsets between an AR headset and a rendering engine 150 without needing to transfer the data contained in a projection of the 3D image data set or without sending video of what one AR headset is seeing to the rendering engine. Sending large graphical data sets can consume a lot of bandwidth and/or use a high speed wired connection. Most operating rooms in the US and especially in foreign countries cannot guarantee high speed wired connections to transfer large graphical data sets or video in real time between AR headsets or a rendering service with a display in the same operating room. Accordingly, transferring the positional data of the AR headsets, an instrument position, the patient orientation, a user interface state, etc. to a rendering engine 150 may useful in the training and/or assistance of other medical professionals.

The present technology further includes a system and method for sharing a first user view and/or a second user view of an image data set aligned with a body of a person using AR headsets. The image data set may be aligned with anatomical structures of the person using at least one marker (e.g., an optical marker) on the person, using morphometrics, using radiopaque markers, or other alignment methods referenced in this disclosure. An image data set can be aligned to the body of the person using a marker or other alignment systems. Medical imaging may be obtained and aligned with a body of a person. For example, a CT (computed tomography) scan, MRI (magnetic resonance imaging) image or other imaging may be overlaid on the patient and used as a reference for aspects of a patient's anatomical structure being operated on. U.S. Pat. Nos. 9,892,564; 10,475,244; 11,004,271; 10,010,379; 10,945,807; 11,266,480; 10,825,563; 11,237,627; 11,287,874; U.S. patent application Ser. No. 17/706,462 entitled “Using Optical Codes with Augmented Reality Displays”; and U.S. patent application Ser. No. 17/536,009 entitled “Image Data Set Alignment for an AR Headset Using Anatomic Structures and Data Fitting”; and U.S. patent application Ser. No. 17/978,962 entitled “3D Spatial Mapping in a 3D Coordinate System of an AR Headset Using 2D Images” describe methods and systems for aligning an image data set from medical imaging devices with a body of a person and these descriptions are incorporated in their entirety by reference herein. An image data set may be aligned to the body of the person using: markers, optical codes, radiopaque markers, 2D imaging, morphometrics or other systems for alignment of 3D image data sets. These patents also describe a wide variety of medical imaging types that may be used to obtain 3D image data sets.

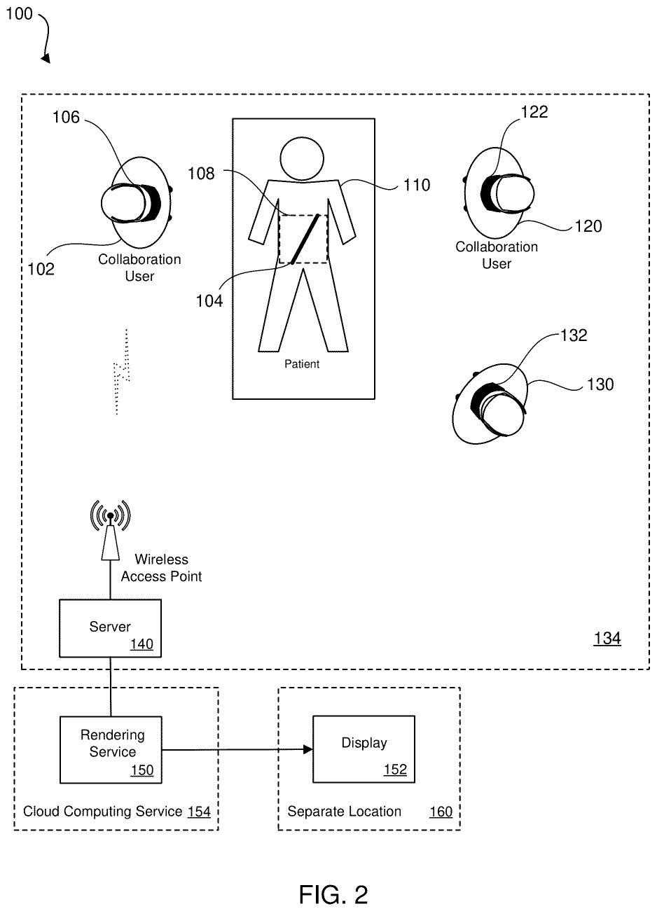

FIG. 2 illustrates that in one embodiment, the rendering service 150 can be hosted in cloud computing service 154. This cloud computing service may be a service provider environment (e.g., a public cloud or a private cloud) and the rendered first user view can be sent from the cloud computing service 154 across the internet to a 2D display 152 in a separate location 160.

Accordingly, the present technology allows a user to share a user view of an image data set in the same room (e.g., an operating room) or across the world to another headset. Specifically, the system can be setup to allow a user of an AR headset or wearable display to share the user's view to another computer device that can render the 3D image from an image data set and display the rendered image on a planar screen. For example, a user view can be rendered from the doctor's perspective based on position and orientation information from an AR headset the doctor or surgeon is wearing when looking at a patient. The use of the rendering service 150 provides one or more other people in the world with the ability to see exactly what the doctor is seeing and this can provide the opportunity for a virtual meeting. The receivers of the user view can receive a rendering of a 3D image data set. In one example, it may be a 2D image on a 2D screen representing a 3D image data set because a receiver of the rendering may not have stereoscopic feeds with their device. Alternatively, a stereoscopic rendering may be sent to a stereoscopic display. This sharing of the rendering allows the system to share the first person view from a doctor or a surgeon to another device without having to stream video data that would consume high bandwidth data. As discussed, position information can be sent to a second device which performs image rendering and displays the resulting image.

In addition to the rendering of the image data set using the rendering service 150, a background image can also be displayed with the rendering of the image data set that shows the patient and/or the room background. For example, the rendering may be shown with a background image that is a 2D shot of the patient. Alternatively, background image may be video frames or streaming video when the appropriate amount of network bandwidth is available. The rendering service may generate rendered images from the image data set, virtual images available in AR or VR, video frames of the background, 2D background images or any combination of these elements.

As discussed earlier, one of the biggest challenges is that in most operating rooms, the OR rooms do not have the available bandwidth for high speed transfers. This is especially true in foreign countries where it can be hard to transfer video data because the ORs have not been wired to provide high speed bandwidth. The present technology can avoid this issue because the system can send the position and orientation of a user who is sharing their view of the image data set to a local computer or a remote server for rendering of the view of the image data set and this takes position and orientation data consumes relatively little bandwidth. The computer with the rendering engine can also provide the ability for the sharing user and the receiving user to share controls for controlling the view of the image data set.

In one configuration, an additional user may be allowed to access a user interface through the rendering service to control or change the first user view of the image data set or control navigation of the image data set. This provides a user of the rendering service shared controls with the first user. The first user and a user interface (UI) associated with a rendering service with a shared user interface may share the UI functions that include, for example: altering a position of the image data set in the 3D coordinate system, moving to a different slice in the image data set, rotating a projection slice, and using graphical user interface (GUI) controls from their own perspective. Thus, the rendering service 150 can receive instructions from a user to perform functions from a perspective of the first user, as just described. Those changes made by the rendering service 150 can be propagated to other AR headsets including the first user's AR headset.

Two views may be provided on the display 152 for a user, if desired. For example, an additional user with a second AR headset may be identified in the 3D coordinate space. The position and orientation of the additional user in the 3D coordinate space with respect to the person being viewed or patient may be sent to the rendering service 150 to enable rendering of a second view of the image data set from the position of the additional user. The second view of the image data set may be displayed in proximity to or adjacent to the first user view using the 2D display 152. The first AR headset and the second AR headset may use a common 3D coordinate space in a location.

Additional data representing the first user view can be sent to the rendering service with the 2D display, and that data may include: at least one projection slice viewed from a perspective of the first user, a location and orientation of the first user in the 3D coordinate space, a depth of at least one projection slice, a medical device location, object locations or a pointer location.

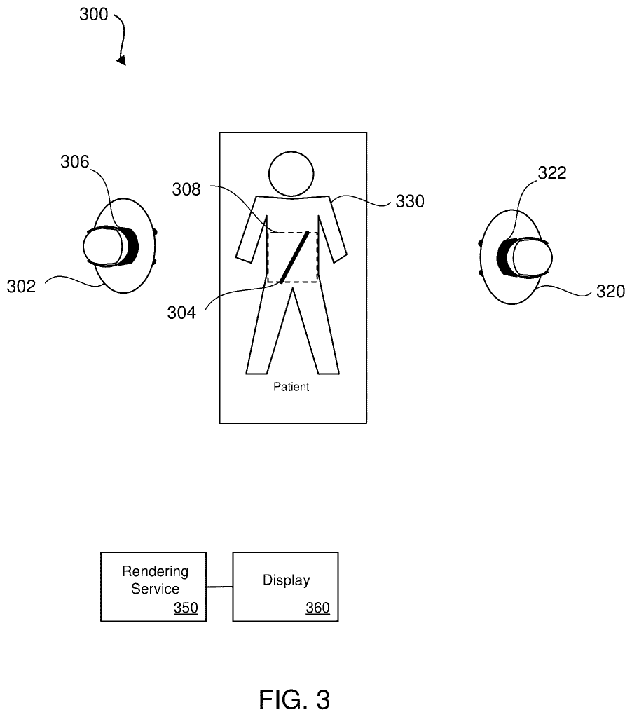

FIG. 3 illustrates that a first user view of the image data set 308 may be determined based in part on a position of a first user 302 in a 3D coordinate space 300 as defined using a first AR headset 306. A second user 320 with a second AR headset 322 having a second user view may be identified in the 3D coordinate space 300. The first user view and the second user view may include information about a pose of the AR headset and a coordinate location of the AR headset. Accordingly, the first AR headset and the second AR headset may use a common 3D coordinate system in a location. The 3D coordinate system may be set by a single AR headset or through negotiation of the AR headsets. The location of the AR headsets may be in an operating room, examination room, training room, clinic, hospital room or another location where a medical procedure may be desired to be performed on the body of a person.

The first user's position in the 3D coordinate space with respect to the person may be sent to the rendering service 350 and display 360 that is located in the same room as the first user and second user or in a distant location. The first user's position may be a Cartesian coordinate or another coordinate in the 3D coordinate space (e.g., polar coordinates or another coordinate space system) that is detected using the first AR headset 306.

In another example, a first user may be allowed to control a rendering service 350 view of the image data set or the first user may control navigation of the rendering service 350 and display 360. This means that when the first user moves the 3D slice through the CT scan or MRI scan then the 3D slice will also move for the display 360 of the rendering service 350.

In another example, a second user may be allowed to control a rendering engine 350 view of the image data set. If the second user moves the 3D slice by using hand gestures or finger gestures, the view of the 3D slice may be moved for the rendering engine 350 and display 360. Any navigation changes made by the second user can be propagated to the rendering engine 350 and the 2D display 360.

The ability to share the same view of an image data set between two augmented reality (AR) headsets is provided. The AR headsets can send positional information regarding the first user out to the second user with a second AR headset. The second user may see an avatar of the first doctor's head so the second user can see how the doctor is looking at the patient (the first AR headset knows and has sent the position of the surgeon). The second user can view the image data set from the primary surgeon's position or have the system render and send the information from that perspective. The second user can also view the image data set from the orthogonal position. Not only can the AR headset of the first user send positional information but remote commands too.

The user interface may also be configured so that both the first user (e.g., doctor) and the second user (e.g., doctor) can each alter a 3D slice position and orientation, drag the slice through the image data set to see different slice layers, rotate the cut, etc. These shared controls may apply to any number of users or medical professionals in the same 3D coordinate system and the 2D display system. The other users or medical professionals who have connected to the primary user's sessions can see the virtual elements in the AR headset from their own perspective or the primary doctor's perspective.

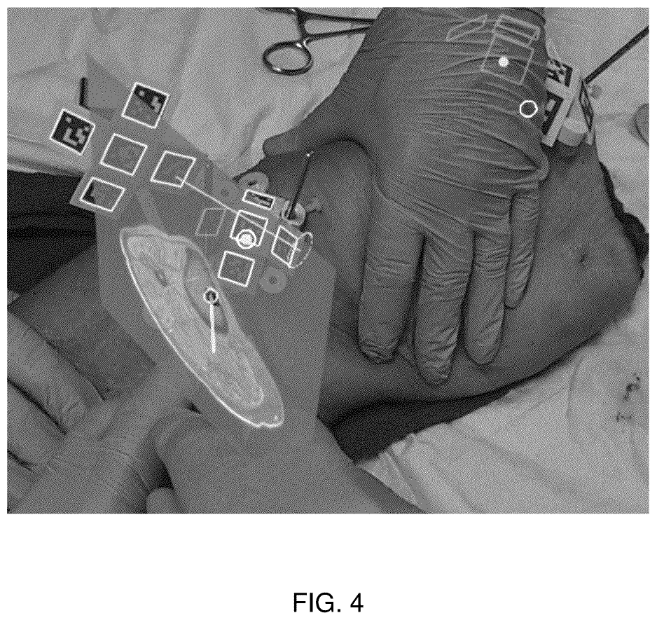

FIG. 4 illustrates a slice of the image data set that may be viewed from a first user's perspective, and the use of a medical instrument and representation of a virtual medical instrument (e.g., a burr) on a patient's anatomy (i.e., a cadaver in this image).

Data representing the first user view or second user view may also be sent to the rendering engine, and the data may include one or more viewing details. Examples of these viewing details may include sending information about at least one of: the existence of at least one projection slice viewed from a perspective of the first user or second user, a location of the projection slice, a location of the first user or second user in the 3D coordinate space, a depth of at least one projection slice, a medical device location, object locations, a pointer location, or other virtual object and physical object locations.

In another example of the technology, the first user, the second user and the rendering engine may share user interface functions from their own perspectives. A user interface function may include at least one of: altering a position of the image data set in the 3D coordinate system, moving to a different slice in the image data set, rotating a projection slice, changing a projection angle of a slice; identifying a slice of the image data set, and using graphical user interface (GUI) controls from their own perspective. Similarly, the second user or rendering engine user interface may perform functions from a perspective of the first user, including the functions listed above. This means the second user or rendering engine user may see what the first user is seeing and be able to do operations like altering a position of the image data set from the first user's perspective, dragging or rotating a slice in the image data set from the first user's perspective, or using graphical user interface (GUI) controls from the perspective of the second user or rendering engine user. The changes from the first user or second user may be reflected on the 2D display associated with the rendering engine or vice versa.

In the situation where a first user is using a set of graphical user interface (GUI) controls to perform tasks with respect the image data set that is overlaid on the patient, a copy of these same GUI controls may also be presented to the second user or rendering engine user while facing the second user or rendering engine user so that the second user or rendering engine user can see the things the first user is doing with the GUI interface. For example, if the first user presses virtual button A, then the second user will see their own copy of the interface facing the second user with the virtual button A pushed. Alternatively, the second user may see the first user's interface from a different perspective of the first user. For example, if the first user presses button A, then the second user can see that button A is pressed on the first user's copy of the user interface. This type of user interface can also be replicated for the rendering engine and used by the user of the 2D display and rendering engine.

As mentioned earlier, the rendering engine and 2D display may also provide navigation views or alternative perspective views of the image data set. This might include seeing views of the image data set from perspectives that are different than where the first user or second user is actually standing. These views might be a view at an angle to the first or second user's view, the views may be top and bottom views or other oblique views that may be useful to the medical procedure being undertaken. Accordingly, the first user, second user or rendering engine user interface may switch to or use a panel (e.g., a graphical panel or pane presented in the AR headset) having at least one alternative perspective view of the image data set as defined with respect the second user view and second user's position. Further, at least one navigational view may be presented to the second user or user of the 2D display associated with the rendering engine. The navigational views may be at least one of: a view of the image data set that is orthogonal to the original user view, a custom perspective defined by the original user, a defined view of a medical guide or medical implement in the medical procedure, or a defined view that is aligned and locked to a body of a person (e.g., an axis of the body of the person). A navigation view may include thumbnail views on a user interface bar viewable through the first AR headset and/or second AR headset.

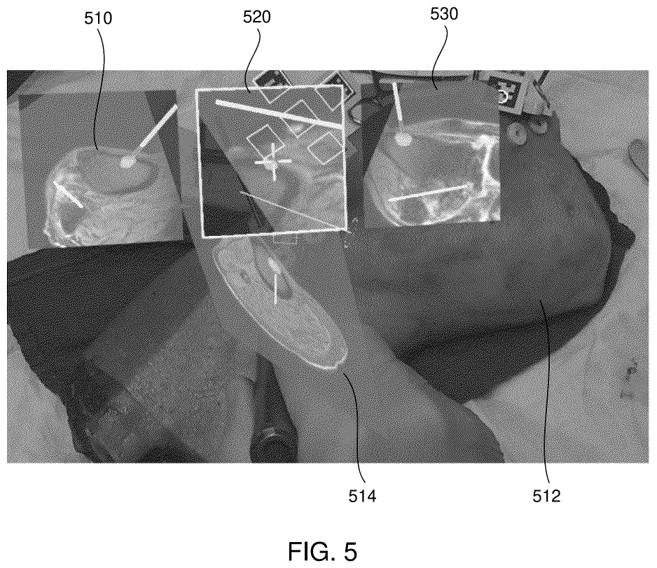

At least one navigational view can be presented using the rendering service. The rendering service may also be able to control or manage navigation panels as illustrated in FIG. 5. The rendering service can switch to a panel having at least one alternative perspective view of the image data set as defined by the first user view and first user's position. The navigation views may be at least one of: a view of the image data set that is orthogonal to the second user view, a custom perspective set by the second user, a defined view of a medical guide, or a defined view that is locked to a body of a person. Another navigation view may include thumbnail views on a user interface bar viewable through the first AR headset or the second AR headset.

FIG. 5 illustrates an example of a slice 514 of a 3D image data set that may be displayed as an overlay to anatomy 512 using the AR headset. A heads up display of multiple breakout views 510, 520, 530 of the X-ray generated images is also displayed. The breakout view may show navigational views of a 3D slice of the 3D image data or the entire image data set desired by a medical professional (e.g., orthogonal to the AR headset view, etc.) as overlays. The breakout views can be navigational views illustrating 3D slices from other perspectives for viewing the overlaid 3D slice. For example, coronal, axial and sagittal views, etc. may be provided.

The navigation (or break-out) views can also be used by a medical professional to tell the medical professional how close they are to a target from a selected perspective. Otherwise, it can be difficult to determine a distance to and orientation of a medical instrument with respect to a target in three dimensions. In one configuration of this technology, the second medical professional may see the break-out view (e.g., in a mini view) from the same perspective as the primary medical professional or first doctor. In another view configuration, the second medical professional can see the primary view and the break-out view from the second medical professional's own perspective. In another alternative, the first and second medical professionals may want to see some of these elements aligned with or locked to the patient anatomy. Then both the first medical professional and second medical professional will see the primary view and/or breakout views the same way regardless of their physical location in the 3D coordinate system of an operating room. The opportunity to set the various views allows the medical professional to individually determine whether they want to see the views from their own perspective in the 3D coordinate system or from the view the primary doctor is currently seeing.

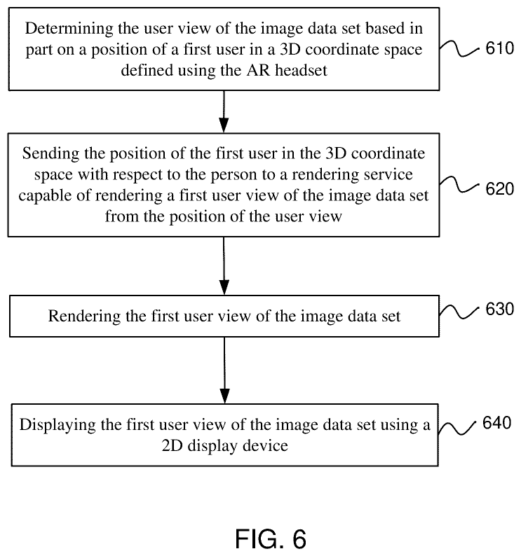

FIG. 6 is a flowchart illustrating a method for displaying a user view of an image data set aligned with a body of a person during a medical procedure, as received from an AR headset. The method may be performed using at least one processor and at least one memory device including a data store to store a plurality of data and instructions that may be executed.

The method may include performing the operation of determining the user view of the image data set based in part on a position of a first user in a 3D coordinate space defined using the AR headset, as in block 610. The position of the first user in the 3D coordinate space with respect to the person may be sent to a rendering service capable of rendering a first user view of the image data set from the position of the user view, as in block 620.

The first user view of the image data set may be rendered by a rendering service, as in block 630. The rendering service may be a rendering device located in proximity to where the AR headset is being operated or the rendering service may be located in a cloud service (e.g., Amazon Web Services (AWS), Microsoft Azure, Google Cloud Platform (GCP), etc.) The AR headset of the first user and the rendering service are connected through at least one of: a collaboration server, Bluetooth or Wi-Fi.

The first user view of the image data set may be displayed using a 2D display device, as in block 640. The 2D display device may be at least one of: an LCD screen, an OLED screen, an image projector or a plasma screen.

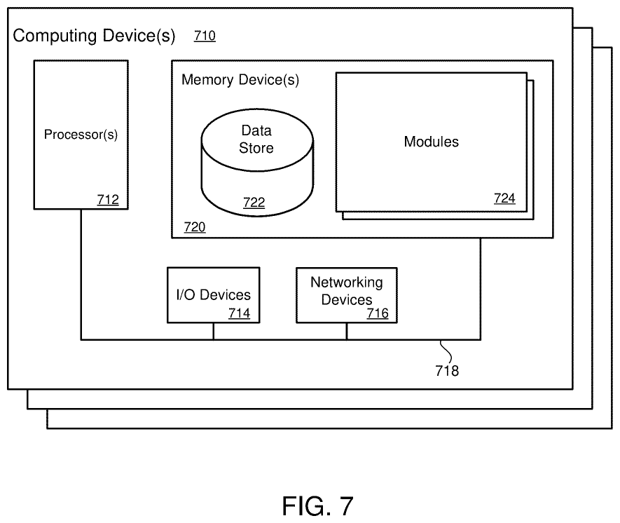

FIG. 7 illustrates a computing device 710 on which modules of this technology may execute. The computing device 710 is illustrated on which a high level example of the technology may be executed. The computing device 710 may include one or more processors 712 that are in communication with memory devices 720. The computing device may include a local communication interface 718 for the components in the computing device. For example, the local communication interface may be a local data bus and/or any related address or control busses as may be desired.

The memory device 720 may contain modules 724 that are executable by the processor(s) 712 and data for the modules 724. The modules 724 may execute the functions described earlier. A data store 722 may also be located in the memory device 720 for storing data related to the modules 724 and other applications along with an operating system that is executable by the processor(s) 712.

Other applications may also be stored in the memory device 720 and may be executable by the processor(s) 712. Components or modules discussed in this description that may be implemented in the form of software using high level programming languages that are compiled, interpreted or executed using a hybrid of the methods.

The computing device may also have access to I/O (input/output) devices 1014 that are usable by the computing devices. An example of an I/O device is a display screen that is available to display output from the computing devices. Other known I/O device may be used with the computing device as desired. Networking devices 716 and similar communication devices may be included in the computing device. The networking devices 716 may be wired or wireless networking devices that connect to the internet, a LAN, WAN, or other computing network.

The components or modules that are shown as being stored in the memory device 720 may be executed by the processor 712. The term “executable” may mean a program file that is in a form that may be executed by a processor 712. For example, a program in a higher level language may be compiled into machine code in a format that may be loaded into a random access portion of the memory device 720 and executed by the processor 712, or source code may be loaded by another executable program and interpreted to generate instructions in a random access portion of the memory to be executed by a processor.

The executable program may be stored in any portion or component of the memory device 720. For example, the memory device 720 may be random access memory (RAM), read only memory (ROM), flash memory, a solid state drive, memory card, a hard drive, optical disk, floppy disk, magnetic tape, or any other memory components. The processor 712 may represent multiple processors and the memory 720 may represent multiple memory units that operate in parallel to the processing circuits. This may provide parallel processing channels for the processes and data in the system. The local interface 718 may be used as a network to facilitate communication between any of the multiple processors and multiple memories. The local interface 718 may use additional systems designed for coordinating communication such as load balancing, bulk data transfer, and similar systems.

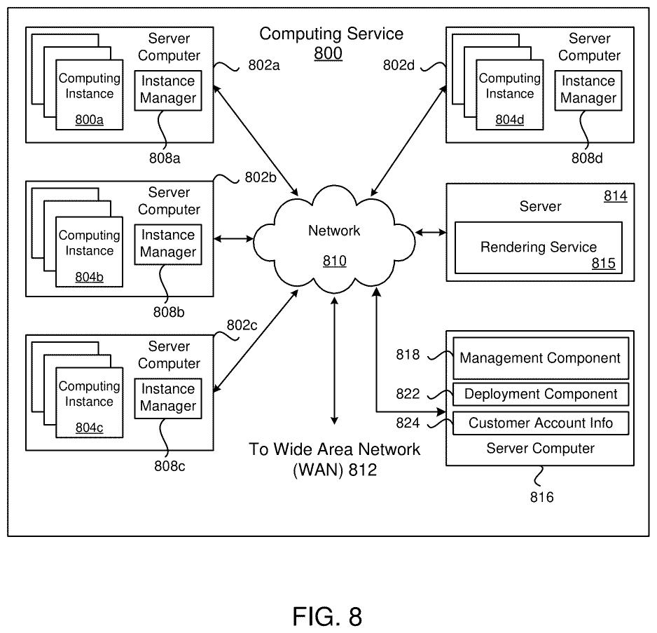

FIG. 8 is a block diagram illustrating an example computing service 800 that may be used to execute and manage a number of computing instances 804a-d upon which the present technology may execute. In particular, the computing service 800 depicted illustrates one environment in which the technology described herein may be used. The computing service 800 may be one type of environment that includes various virtualized service resources that may be used, for instance, to host computing instances 804a-d.

The computing service 800 may be capable of delivery of computing, storage and networking capacity as a software service to a community of end recipients. In one example, the computing service 800 may be established for an organization by or on behalf of the organization. That is, the computing service 800 may offer a “private cloud environment.” In another example, the computing service 800 may support a multi-tenant environment, wherein a plurality of customers may operate independently (i.e., a public cloud environment). Generally speaking, the computing service 800 may provide the following models: Infrastructure as a Service (“IaaS”) and/or Software as a Service (“SaaS”). Other models may be provided. For the IaaS model, the computing service 800 may offer computers as physical or virtual machines and other resources. The virtual machines may be run as guests by a hypervisor, as described further below. The PaaS model delivers a computing system that may include an operating system, programming language execution environment, database, and web server.

Application developers may develop and run their software solutions on the computing service system without incurring the cost of buying and managing the underlying hardware and software. The SaaS model allows installation and operation of application software in the computing service 800. End customers may access the computing service 800 using networked client devices, such as desktop computers, laptops, tablets, smartphones, etc. running web browsers or other lightweight client applications, for example. Those familiar with the art will recognize that the computing service 800 may be described as a “cloud” environment.

The particularly illustrated computing service 800 may include a plurality of server computers 802a-d. The server computers 802a-d may also be known as physical hosts. While four server computers are shown, any number may be used, and large data centers may include thousands of server computers. The computing service 800 may provide computing resources for executing computing instances 804a-d. Computing instances 804a-d may, for example, be virtual machines. A virtual machine may be an instance of a software implementation of a machine (i.e. a computer) that executes applications like a physical machine. In the example of a virtual machine, each of the server computers 802a-d may be configured to execute an instance manager 808a-d capable of executing the instances. The instance manager 808a-d may be a hypervisor, virtual machine manager (VMM), or another type of program configured to enable the execution of multiple computing instances 804a-d on a single server. Additionally, each of the computing instances 804a-d may be configured to execute one or more applications.

A server 814 may be reserved to execute software components for implementing the present technology or managing the operation of the computing service 800 and the computing instances 804a-d. For example, the server 814 may include rendering service 815.

A server computer 816 may execute a management component 818. A customer may access the management component 818 to configure various aspects of the operation of the computing instances 804a-d purchased by a customer. For example, the customer may setup computing instances 804a-d and make changes to the configuration of the computing instances 804a-d.

A deployment component 822 may be used to assist customers in the deployment of computing instances 804a-d. The deployment component 822 may have access to account information associated with the computing instances 804a-d, such as the name of an owner of the account, credit card information, country of the owner, etc. The deployment component 822 may receive a configuration from a customer that includes data describing how computing instances 804a-d may be configured. For example, the configuration may include an operating system, provide one or more applications to be installed in computing instances 804a-d, provide scripts and/or other types of code to be executed for configuring computing instances 804a-d, provide cache logic specifying how an application cache is to be prepared, and other types of information. The deployment component 822 may utilize the customer-provided configuration and cache logic to configure, prime, and launch computing instances 804a-d. The configuration, cache logic, and other information may be specified by a customer accessing the management component 818 or by providing this information directly to the deployment component 822.

Customer account information 824 may include any desired information associated with a customer of the multi-tenant environment. For example, the customer account information may include a unique identifier for a customer, a customer address, billing information, licensing information, customization parameters for launching instances, scheduling information, etc. As described above, the customer account information 824 may also include security information used in encryption of asynchronous responses to API requests. By “asynchronous” it is meant that the API response may be made at any time after the initial request and with a different network connection.

A network 810 may be utilized to interconnect the computing service 800 and the server computers 802a-d, 816. The network 810 may be a local area network (LAN) and may be connected to a Wide Area Network (WAN) 812 or the Internet, so that end customers may access the computing service 800. In addition, the network 810 may include a virtual network overlaid on the physical network to provide communications between the servers 802a-d. The network topology illustrated in FIG. 8 has been simplified, as many more networks and networking devices may be utilized to interconnect the various computing systems disclosed herein.

Some of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more blocks of computer instructions, which may be organized as an object, procedure, or function. Nevertheless, the executables of an identified module need not be physically located together, but may comprise disparate instructions stored in different locations which comprise the module and achieve the stated purpose for the module when joined logically together.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices. The modules may be passive or active, including agents operable to perform desired functions.

The technology described here can also be stored on a computer readable storage medium that includes volatile and non-volatile, removable and non-removable media implemented with any technology for the storage of information such as computer readable instructions, data structures, program modules, or other data. Computer readable storage media include, but is not limited to, RAM, ROM, EEPROM, flash memory or other memory technology, CD-ROM, digital versatile disks (DVD) or other optical storage, magnetic cassettes, magnetic tapes, magnetic disk storage or other magnetic storage devices, or any other computer storage medium which can be used to store the desired information and described technology.

The devices described herein may also contain communication connections or networking apparatus and networking connections that allow the devices to communicate with other devices. Communication connections are an example of communication media. Communication media typically embodies computer readable instructions, data structures, program modules and other data in a modulated data signal such as a carrier wave or other transport mechanism and includes any information delivery media. A “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency, infrared, and other wireless media. The term computer readable media as used herein includes communication media.

Furthermore, the described features, structures, or characteristics may be combined in any suitable manner in one or more examples. In the preceding description, numerous specific details were provided, such as examples of various configurations to provide a thorough understanding of examples of the described technology. One skilled in the relevant art will recognize, however, that the technology can be practiced without one or more of the specific details, or with other methods, components, devices, etc. In other instances, well-known structures or operations are not shown or described in detail to avoid obscuring aspects of the technology.

Although the subject matter has been described in language specific to structural features and/or operations, it is to be understood that the subject matter defined in the appended claims is not necessarily limited to the specific features and operations described above. Rather, the specific features and acts described above are disclosed as example forms of implementing the claims. Numerous modifications and alternative arrangements can be devised without departing from the spirit and scope of the described technology.

What is claimed is:

1. A method for sharing views of an image data set, comprising:
determining a first user view of the image data set based in part on a position of a first user in a 3D coordinate space defined using a wearable display device with associated sensors; and
sending the position of the first user in the 3D coordinate space to a rendering service which renders the first user view of the image data set from the position of the first user or substantially the position of the first user in the 3D coordinate system.

2. The method as in claim 1, further comprising displaying the first user view of the image data set received from the rendering service using a display device in order to re-create the first user view.

3. The method as in claim 2, wherein the display device is a 2D display device that is at least one of: an LCD screen, an OLED screen, an image projector or a plasma screen.

4. The method as in claim 2, wherein the display device is a stereoscopic display device or an AR headset.

5. The method as in claim 2, wherein the rendering service is hosted on a rendering device located in proximity to where a display device is being operated.

6. The method as in claim 1, wherein the rendering service is hosted in a service provider environment and the first user view is sent across a network to a 2D display device.

7. The method as in claim 1, wherein the wearable display device of the first user and the rendering service are connected through at least one of: a collaboration server, Bluetooth or Wi-Fi.

8. The method as in claim 1, further comprising displaying at least a portion of the image data set from a perspective that matches the user view of the image data set.

9. The method as in claim 1, further comprising allowing a second user to access a user interface associated with the rendering service to control the user view of the image data set or control navigation.

10. The method as in claim 1, further comprising compositing a background with the first user view of the image data set that is a still image or at least one frame from video from a camera of the wearable display device.

11. The method as in claim 1, further comprising:
identifying an additional user with a second wearable display device in the 3D coordinate space;
sending the position of the additional user in the 3D coordinate space with respect to a person to the rendering service to enable rendering of a second view of the image data set from the position of the additional user; and
displaying the second view of the image data set with the first user view using a 2D display device.

12. The method as in claim 11, wherein the wearable display device and the second wearable display device are using a common 3D coordinate space in a location.

13. The method as in claim 2, wherein data representing the first user view is sent to the rendering service with the display device, including at least one of:
at least one projection slice viewed from a perspective of the first user,
a location and orientation of the first user in the 3D coordinate space,
a depth of at least one projection slice,
a medical device location,
object locations; or
a pointer location.

14. The method as in claim 1, wherein the wearable display device of the first user and a user interface associated with a rendering service share user interface function that are at least one of:
altering a position of the image data set in the 3D coordinate system,
moving to a different slice in the image data set,
rotating a projection slice, and
using graphical user interface (GUI) controls from their own perspective.

15. The method as in claim 1, wherein the rendering service performs functions from a perspective of the first user that are at least one of:
altering a position of the image data set,
dragging to a different slice in the image data set,
rotating a projection slice, and
using graphical user interface (GUI) controls from the perspective of the first user.

16. The method as in claim 1, further comprising enabling the rendering service to switch to a panel having at least one alternative perspective view of the image data set as defined by the first user view and first user's position.

17. The method as in claim 1, wherein at least one navigation view is presented using the rendering service.

18. The method as in claim 17, wherein the at least one navigation view may be at least one of: the first user view of the image data set that is orthogonal to the first user view, a custom perspective set by the first user, a defined view of a medical guide, or a defined view that is locked to a body of a person.

19. The method as in claim 17, wherein the at least one navigation view includes thumbnail views on a user interface bar viewable through the rendering service and display device.

20. A system for sharing a user view of an image data set aligned with a body of a person during a medical procedure, as viewed using an AR headset, comprising:
at least one processor;
at least one memory device including a data store to store a plurality of data and instructions that, when executed, cause the system and processor to:
determining the user view of the image data set based in part on a position of a first user in a 3D coordinate space defined using the AR headset;
sending the position of the first user in the 3D coordinate space to a rendering service capable of rendering a first user view of the image data set from the position of the first user;
rendering the first user view of the image data set; and
displaying the first user view of the image data set using a 2D display device.

21. The system as in claim 20, wherein the 2D display device is at least one of: an LCD screen, an OLED screen or a plasma screen.

22. The system as in claim 20, wherein the rendering service is a rendering device located in proximity to where the AR headset is being operated.

23. The system as in claim 20, wherein the AR headset of the first user and the rendering service are connected through at least one of: a collaboration server, Bluetooth or Wi-Fi.

24. A machine-readable storage medium having instructions embodied thereon, the instructions when executed by one or more processors, cause the one or more processors to perform a process comprising:
determining a user view of an image data set based in part on a position of a first user in a 3D coordinate space defined using an AR headset;
sending the position of the first user in the 3D coordinate space of the AR headset to a rendering service capable of rendering a first user view of the image data set from the position of the user view;
rendering the first user view of the image data set; and
displaying the first user view of the image data set using a 2D display device.

25. The machine-readable storage medium as in claim 24, wherein the 2D display device is at least one of: an LCD screen, an OLED screen or a plasma screen.

26. The machine-readable storage medium as in claim 24, wherein the rendering service is a rendering device located in proximity to where the AR headset is being operated.
